(19) United States
(12) Patent Application Publication
(10) Pub. No.: US 2020/0082415 A1
(43) Pub. Date: Mar. 12, 2020

(54) SENTIMENT ANALYSIS OF NET PROMOTER SCORE (NPS) VERBATIMS

(71) Applicant: Microsoft Technology Licensing, LLC, Redmond, WA (US)

(72) Inventor: Christopher LaTerza, Redmond, WA (US)

(21) Appl. No.: 16/127,556

(22) Filed: Sep. 11, 2018

(51) Int. Cl. G06Q 30/02; G06N 99/00; G06F 17/27

(52) U.S. Cl. CPC G06Q 30/0201; G06F 17/27; G06N 99/005

(57) ABSTRACT

A system for identifying a sentiment accesses net promoter scores (NPS) and corresponding text data. The corresponding text data are filtered based on a maximum value of the NPS and a minimum value of the NPS. The system uses a learning algorithm to train a model based on the filtered text data and the corresponding maximum or minimum value of the NPS.

### TECHNICAL FIELD

The subject matter disclosed herein generally relates to a special-purpose machine that generate a model and use the model to identify NPS sentiment, including computerized variants of such special-purpose machines and improvements to such variants, and to the technologies by which such special-purpose machines become improved compared to other special-purpose machines that evaluating sentiment based on NPS scores. Specifically, the present disclosure addresses systems and methods that train a model and use the model to identify NPS sentiment using text data corresponding to the NPS scores.

### BACKGROUND

Customer feedback forms include text feedback from the customers in addition to star ratings. Sentiment analysis of the text feedback can include both positive and negative information in a single review which makes analysis of the text feedback difficult.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates a sentiment analysis application in accordance with one example embodiment.

FIG. 3 illustrates a process for training a model in accordance with one example embodiment.

FIG. 4 illustrates a flow diagram in accordance with one example embodiment.

FIG. 5 illustrates a flow diagram in accordance with one example embodiment.

FIG. 6 illustrates a routine in accordance with one example embodiment.

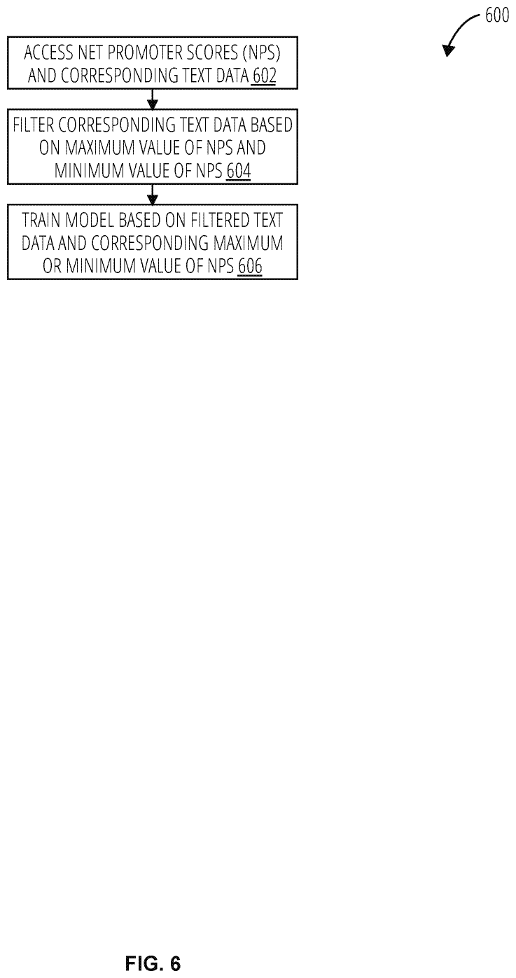

FIG. 7 is a diagrammatic representation of a machine in the form of a computer system within which a set of instructions may be executed for causing the machine to perform any one or more of the methodologies discussed herein, according to an example embodiment.

### DETAILED DESCRIPTION

### Glossary

“Component” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Communication Network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Machine-Storage Medium” in this context refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Processor” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Carrier Signal” in this context refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Signal Medium” in this context refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“Computer-Readable Medium” in this context refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

### DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Net Promoter Score (NPS) is an industry standard for gauging customer satisfaction. An important component to NPS is the freeform text feedback left by customers. However, star rating or NPS score is not a reliable signal for customer satisfaction. For example, a customer may leave a poor rating while praising some aspects of a service or product in the text feedback. Conversely, another customer may leave a high rating while criticizing some features of the service or product in the text feedback.

Sentiment analysis, especially when performed at the sentence level, offers a more granular view into the customers subjective opinions. One specific problem that the sentence-level analysis addresses are verbatims with mixed sentiment (e.g., positive and negative sentences appearing together in the same feedback). Also, sentiment analysis provides different perspective than the star rating alone, as some highly rated feedbacks contains negative comments, and likewise some low rated feedbacks contain positive comments.

The present application describes a binary sentiment analysis model that classifies a sentence as negative or positive together with a probabilistic confidence score. An example of deep learning algorithm used to build the model is a Convolutional Neural Network (CNN) with pre-trained word embeddings. Those of ordinary skills in the art will recognize that alternate machine learning algorithms such as SVM, LogReg, Random Forest, and LSTM, may be used to generate the binary sentiment analysis model.

Usually for natural language processing tasks such as sentiment analysis, humans have to manually annotate each piece of training and test data as positive or negative. Instead, the presently described binary sentiment analysis model relies on the NPS star ratings as proxy for human-annotated labels. For example, 1-star responses are considered as negative examples, and 5-star responses as positives. This allows for rapid collection of a large training set on the order of tens of thousands of training examples.

As such, a deep learning (CNN) model for sentence-level sentiment analysis of Net Promoter Score (NPS) verbatims that has 91% f1-score is described. The CNN model uses a binary sentiment analysis model that classifies a sentence as negative or positive together with a probabilistic confidence score. Some benefits of this model is the way that labeled data is collected, enabling proxy for human-annotated labels, instead of human manual annotations.

The present application describes using star ratings as a proxy for human-annotated labels and a neural network was trained using a specific subset of review data from a single set of feedback data. Using the star ratings as proxy data, the trained CNN is able to determine correct meaning of the human text feedback with improved accuracy vs other systems.

In one example embodiment, a sentiment analysis application accesses net promoter scores (NPS) and corresponding text data. The sentiment analysis application filters the corresponding text data based on a maximum value of the NPS and a minimum value of the NPS. A model is trained based on the filtered text data and the corresponding maximum or minimum value of the NPS.

As a result, one or more of the methodologies described herein facilitate solving the technical problem of training a learning model to evaluate sentiment in text feedback. As such, one or more of the methodologies described herein may obviate a need for certain efforts or computing resources that otherwise would be involved in manually labeling of a training set for training a model to evaluate mixed sentiment feedback. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

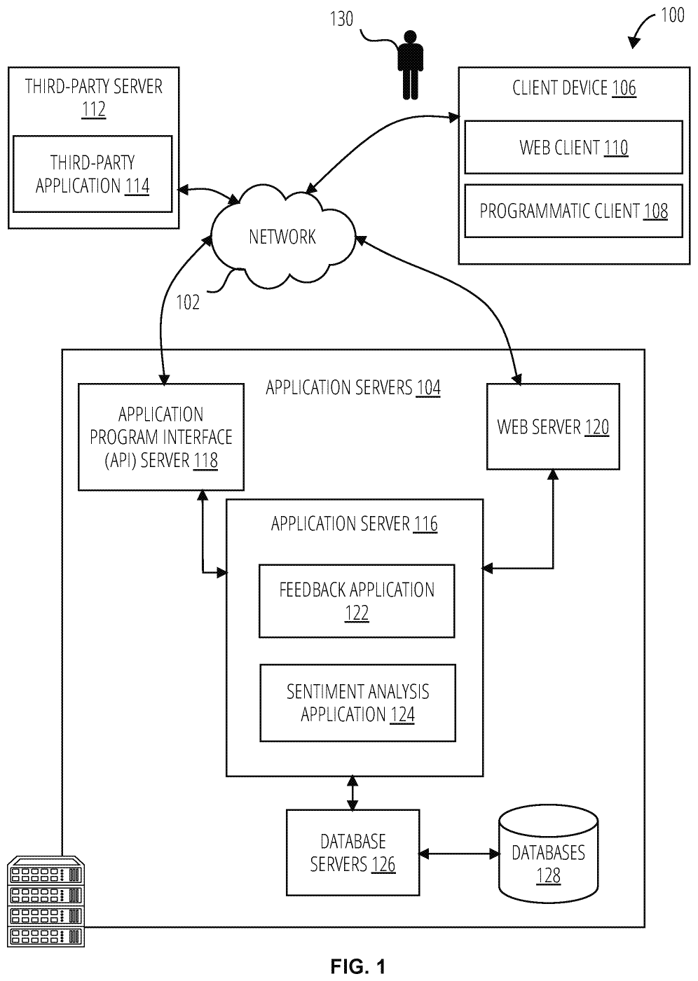

FIG. 1 is a diagrammatic representation of a network environment 100 in which some example embodiments of the present disclosure may be implemented or deployed. One or more application servers 104 provide server-side functionality via a network 102 to a networked user device, in the form of a client device 110. A web client 110 (e.g., a browser) and a programmatic client 108 (e.g., an “app”) are hosted and execute on the web client 110.

An Application Program Interface (API) server 118 and a web server 120 provide respective programmatic and web interfaces to application servers 104. A specific application server 116 hosts a feedback application 122 and a sentiment analysis application 124 which includes components, modules and/or applications.

The web client 110 communicates with the feedback application 122 via the web interface supported by the web server 120. Similarly, the programmatic client 108 communicates with the feedback application 122 via the programmatic interface provided by the Application Program Interface (API) server 118. The third-party application 114 may, for example, be a service application that provides services to the client device 106. The feedback application 122 seeks feedback related to the service application from the client device 106. The sentiment analysis application 124 analyzes feedbacks related to the service application and generates or train a model that determines a sentiment based on text feedback receives at the feedback application 122.

The application server 116 is shown to be communicatively coupled to database servers 126 that facilitates access to an information storage repository or databases 128. In an example embodiment, the databases 128 includes storage devices that store information to be published and/or processed by the feedback application 122. The feedback application 122 seeks feedback from the user 130 of the client device 106. For example, the feedback application 122 queries the user 130 for a score (e.g., NPS score) and text feedback. In another example, the feedback application 122 queries the user 130 for a score (e.g., NPS score) and text feedback for a service application (not shown) operating at the application server 116. The service application may include a software application that provides operations to or on behalf of the client device 106.

Additionally, a third-party application 114 executing on a third-party server 112, is shown as having programmatic access to the application server 116 via the programmatic interface provided by the Application Program Interface (API) server 118. For example, the third-party application 114, using information retrieved from the application server 116, may supports one or more features or functions on a website hosted by the third party.

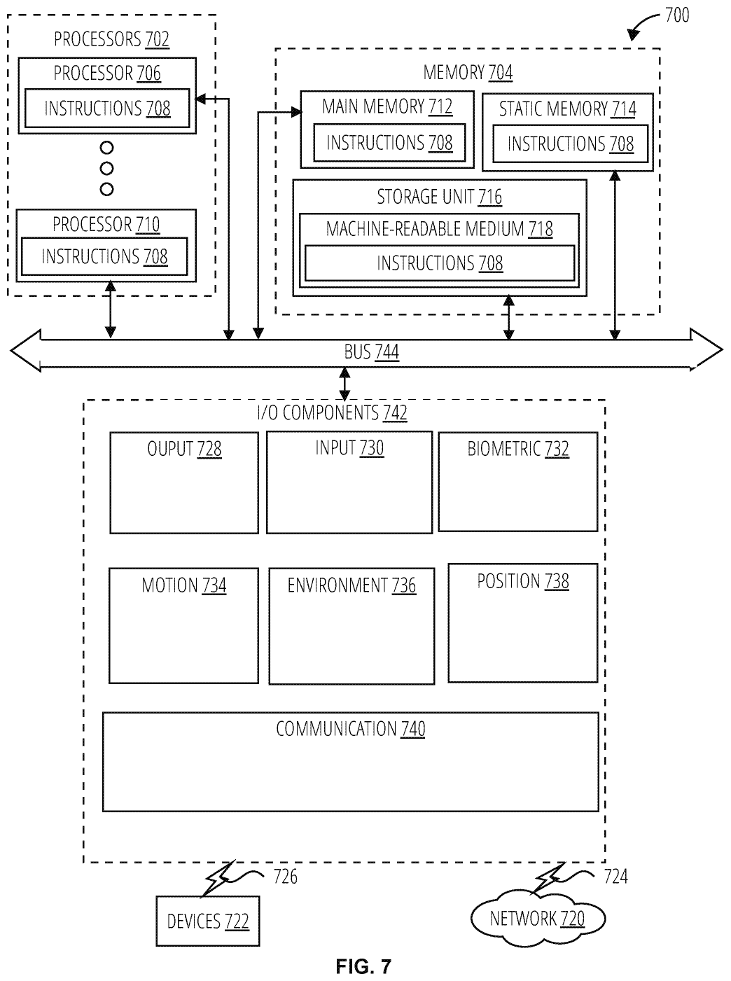

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client device 106 may be embodied within the network environment 100. Furthermore, some components or functions of the network environment 100 may be combined or located elsewhere in the network environment 100. For example, some of the functions of the client device 106 may be embodied at the application server 116.

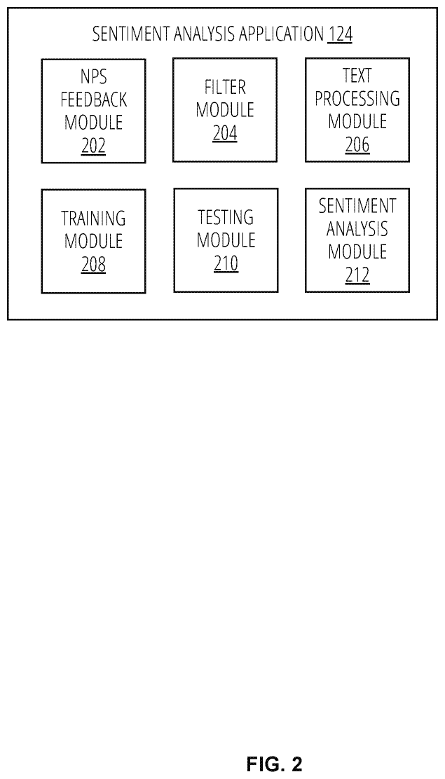

FIG. 2 illustrates the sentiment analysis application 124 in accordance with one example embodiment. The sentiment analysis application 124 includes an NPS feedback module 202, a filter module 204, a text processing module 206, a training module 208, a testing module 210, and a sentiment analysis module 212. The NPS feedback module 202 communicates with the feedback application 122 to access NPS scores and corresponding feedback text data. The filter module 204 filters the scores and identifies ratings with only the minimum score and maximum score (e.g., ratings with 1 or 5 based on a rating scale of 1 to 5). The text processing module 206 preprocesses the filtered text data corresponding to the filtered ratings (e.g., text data from a 1 star rating and text data from a 5 star rating). For example, the text processing module 206 parses the text data to identify words and sentences. The training module 208 trains a model based on the filtered text data and corresponding ratings. In one example embodiment, the training module 208 uses a CNN to train the model.

The testing module 210 tests the model to determines its accuracy. For example, the testing module 210 compares the results of the trained model on human-labeled test data to determine the accuracy of the model. The sentiment analysis module 212 receives text feedback data and corresponding NPS score, applies the trained model to the text feedback data and corresponding NPS score to determine a sentiment of the text feedback data.

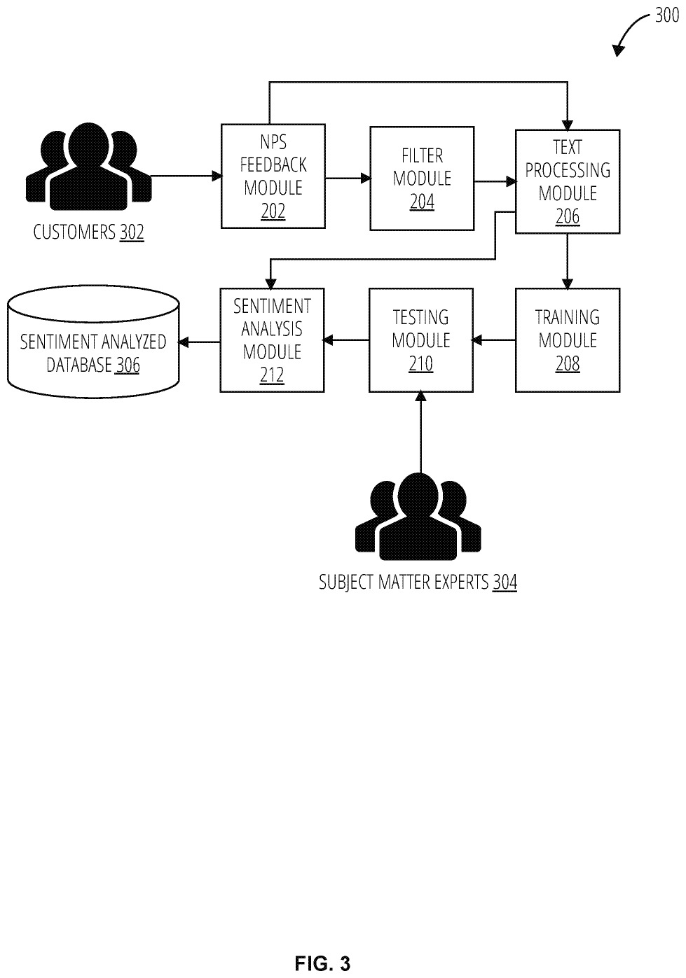

FIG. 3 illustrates a process for training a model in accordance with one example embodiment. Customers 302 provides 0 score and corresponding text feedback data to the NPS feedback module 202. The filter module 204 filters the data using text data associated with the minimum and the maximum value (e.g., NPS score of 1 and 5). The text processing module 206 preprocesses the filtered data and provides the filtered data to the training module 208. The training module 208 uses CNN to train a model based on the filtered data. The testing module 210 tests the train model based on human-labeled test data from subject matter experts 304. In one example embodiment, test data set provided by subject matter experts is of the same level of linguistic granularity as the target dataset that sentiment analysis is being performed on. In the present example, the linguistic granularity is at the sentence-level. Other levels of linguistic granularity can be used in other example embodiments.

Once the testing module 210 determines that the trained model is accurate or has an accuracy exceeding a predefined accuracy threshold, the testing module 210 provides the trained model to the sentiment analysis module 212.

The NPS feedback module 202 receives a new NPS score and a corresponding text data. The text processing module 206 processes the text from the corresponding text data of the new NPS score. The sentiment analysis module 212 identifies a sentiment related to the text data based on the trained model. The sentiment analysis module 212 provides the sentiment data to a sentiment analyzed database 306.

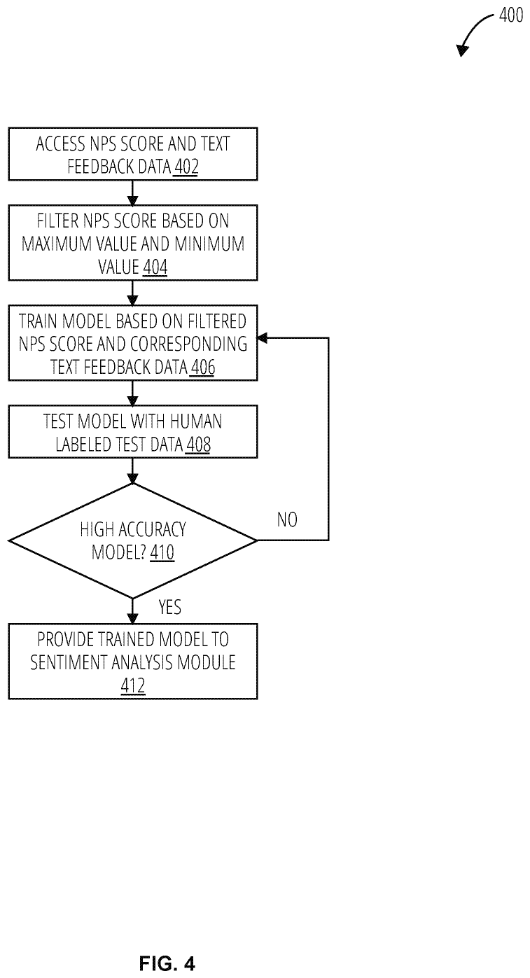

FIG. 4 illustrates a flow diagram 400 in accordance with one example embodiment. Operations in the flow diagram 400 may be performed by the sentiment analysis application 124, using components (e.g., modules, engines) described above with respect to FIG. 2. Accordingly, the flow diagram 400 is described by way of example with reference to the sentiment analysis application 124. However, it shall be appreciated that at least some of the operations of the flow diagram 400 may be deployed on various other hardware configurations or be performed by similar components residing elsewhere. For example, some of the operations may be performed at the application servers 104. At block 402, the NPS feedback module 202 accesses NPS scores and corresponding text data from feedback application 122. At block 404, the filter module 204 filters the NPS score based on the maximum value and minimum value of the NPS score range. At block 406, the training module 208 trains a model based on the filtered NPS score and the corresponding text feedback data. At block 408, the testing module 210 tests the trained model by comparing results from the trained model with human-labeled test data. At decision block 410, the testing module 210 determines whether an accuracy level of the trained model exceeds a threshold. At block 412, the testing module 210 provides the trained model to the sentiment analysis module 212 if the accuracy level of the trained model exceeds the threshold. If the accuracy level of the trained model is below the threshold, the training module 208 retrains the model.

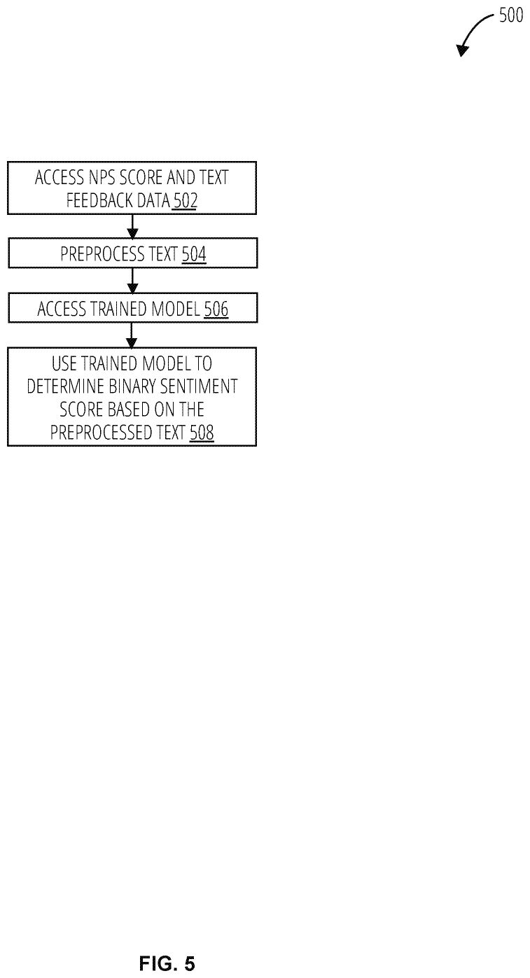

FIG. 5 illustrates a flow diagram in accordance with one example embodiment. Operations in the flow diagram 400 may be performed by the sentiment analysis application 124, using components (e.g., modules, engines) described above with respect to FIG. 3. Accordingly, the flow diagram 400 is described by way of example with reference to the sentiment analysis application 124. However, it shall be appreciated that at least some of the operations of the flow diagram 400 may be deployed on various other hardware configurations or be performed by similar components residing elsewhere. For example, some of the operations may be performed at the application servers 104. At block 502, the NPS feedback module 202 accesses an NPS score and a corresponding text feedback data. At block 504, the text processing module 206 processes the text feedback data. At block 506, the sentiment analysis module 212 accesses the trained model from the training module 208. At block 508, the sentiment analysis module 212 uses the trained model to determine binary sentiment score based on the preprocessed text.

In block 602, routine 600 accesses net promoter scores (NPS) and corresponding text data. In block 604, routine 600 filters the corresponding text data based on a maximum value of the NPS and a minimum value of the NPS. In block 606, routine 600 trains a model based on the filtered text data and the corresponding maximum or minimum value of the NPS.

FIG. 7 is a diagrammatic representation of the machine 700 within which instructions 708 (e.g., software, a program, an application, an applet, an app, or other executable code) for causing the machine 700 to perform any one or more of the methodologies discussed herein may be executed. For example, the instructions 708 may cause the machine 700 to execute any one or more of the methods described herein. The instructions 708 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 708, sequentially or otherwise, that specify actions to be taken by the machine 700. Further, while only a single machine 700 is illustrated, the term “machine” shall also be taken to include a collection of machines that individually or jointly execute the instructions 708 to perform any one or more of the methodologies discussed herein.

The machine 700 may include processors 702, memory 704, and I/O components 742, which may be configured to communicate with each other via a bus 744. In an example embodiment, the processors 702 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 706 and a processor 710 that execute the instructions 708. The term “processor” is intended to include multi-core processors that may comprise two or more independent processors (sometimes referred to as “cores”) that may execute instructions contemporaneously. Although FIG. 7 shows multiple processors 702, the machine 700 may include a single processor with a single core, a single processor with multiple cores (e.g., a multi-core processor), multiple processors with a single core, multiple processors with multiples cores, or any combination thereof.

The memory 704 includes a main memory 712, a static memory 714, and a storage unit 716, both accessible to the processors 702 via the bus 744. The main memory 704, the static memory 714, and storage unit 716 store the instructions 708 embodying any one or more of the methodologies or functions described herein. The instructions 708 may also reside, completely or partially, within the main memory 712, within the static memory 714, within machine-readable medium 718 within the storage unit 716, within at least one of the processors 702 (e.g., within the processor's cache memory), or any suitable combination thereof, during execution thereof by the machine 700.

The I/O components 742 may include a wide variety of components to receive input, provide output, produce output, transmit information, exchange information, capture measurements, and so on. The specific I/O components 742 that are included in a particular machine will depend on the type of machine. For example, portable machines such as mobile phones may include a touch input device or other such input mechanisms, while a headless server machine will likely not include such a touch input device. It will be appreciated that the I/O components 742 may include many other components that are not shown in FIG. 7. In various example embodiments, the I/O components 742 may include output components 728 and input components 730. The output components 728 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 730 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 742 may include biometric components 732, motion components 734, environmental components 736, or position components 738, among a wide array of other components. For example, the biometric components 732 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 include acceleration sensor components (e.g., accelerometer), gravitation sensor components, rotation sensor components (e.g., gyroscope), and so forth. The environmental components 736 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 738 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 742 further include communication components 740 operable to couple the machine 700 to a network 720 or devices 722 via a coupling 724 and a coupling 726, respectively. For example, the communication components 740 may include a network interface component or another suitable device to interface with the network 720. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 722 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geolocation, location via Wi-Fi® signal triangulation, location via detecting an NFC beacon signal that may indicate a particular location, and so forth.

The various memories (e.g., memory 704, main memory 712, static memory 714, and/or memory of the processors 702) and/or storage unit 716 may store one or more sets of instructions and data structures (e.g., software) embodying or used by any one or more of the methodologies or functions described herein. These instructions (e.g., the instructions 708), when executed by processors 702, cause various operations to implement the disclosed embodiments.

The instructions 708 may be transmitted or received over the network 720, using a transmission medium, via a network interface device (e.g., a network interface component included in the communication components 740) and using any one of a number of well-known transfer protocols (e.g., hypertext transfer protocol (HTTP)). Similarly, the instructions 708 may be transmitted or received using a transmission medium via the coupling 726 (e.g., a peer-to-peer coupling) to the devices 722.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

### Examples

Example 1 is a computer-implemented method comprising: accessing net promoter scores (NPS) and corresponding text data; filtering the corresponding text data based on a maximum value of the NPS and a minimum value of the NPS; and training a model based on the filtered text data and the corresponding maximum or minimum value of the NPS.

In example 2, the subject matter of example 1 can optionally include receiving test data comprising human-based labeled test data from a plurality of subject matter experts related to a service application of the NPS; and evaluating the model based on the test data.

In example 3, the subject matter of example 2 can optionally include wherein evaluating the model further comprises: determining an accuracy of the model based on a comparison of an outcome based on the model with an outcome based on the human-based test data.

In example 4, the subject matter of example 3 can optionally include retraining the model in response to determining that the accuracy of the model is lower than an accuracy threshold.

In example 5, the subject matter of example 3 can optionally include receiving a first NPS score and corresponding first text data; in response to determining that the accuracy of the model is higher than an accuracy threshold, determining a sentiment of the first text data based on the model and the first NPS score, the sentiment including a binary indicator, the binary indicator indicating either a positive sentiment for the first text data or a negative sentiment for the first text data.

In example 6, the subject matter of example 1 can optionally include wherein the text data includes feedback data related to a service application.

In example 7, the subject matter of example 1 can optionally include wherein the NPS includes a range from the minimum value to the maximum value.

In example 8, the subject matter of example 7 can optionally include wherein the maximum value corresponds to a positive sentiment, and the minimum value corresponds to a negative sentiment.

In example 9, the subject matter of example 1 can optionally include processing the filtered text data using a text analysis engine.

In example 10, the subject matter of example 1 can optionally include wherein training the model further comprises: using a convolutional neural network to train the model.

What is claimed is:

1. A computer-implemented method, comprising:
accessing net promoter scores (NPS) and corresponding text data;
filtering the corresponding text data based on a maximum value of the NPS and a minimum value of the NPS; and
training a model based on the filtered text data and the corresponding maximum or minimum value of the NPS.

2. The method of claim 1, further comprising:
receiving test data comprising human-based labeled test data from a plurality of subject matter experts related to a service application of the NPS; and
evaluating the model based on the test data.

3. The method of claim 2, wherein evaluating the model further comprises:
determining an accuracy of the model based on a comparison of an outcome based on the model with an outcome based on the human-based test data.

4. The method of claim 3, further comprising:
retraining the model in response to determining that the accuracy of the model is lower than an accuracy threshold.

5. The method of claim 3, further comprising:
receiving a first NPS score and corresponding first text data;
in response to determining that the accuracy of the model is higher than an accuracy threshold,
determining a sentiment of the first text data based on the model and the first NPS score,
the sentiment including a binary indicator, the binary indicator indicating either a positive sentiment for the first text data or a negative sentiment for the first text data.

6. The method of claim 1, wherein the text data includes feedback data related to a service application.

7. The method of claim 1, wherein the NPS includes a range from the minimum value to the maximum value.

8. The method of claim 7, wherein the maximum value corresponds to a positive sentiment, and the minimum value corresponds to a negative sentiment.

9. The method of claim 1, further comprising:
processing the filtered text data using a text analysis engine.

10. The method of claim 1, wherein training the model further comprises:
using a convolutional neural network to train the model.

11. A computing apparatus, the computing apparatus comprising:
a processor; and
a memory storing instructions that, when executed by the processor, configure the apparatus to:
access net promoter scores (NPS) and corresponding text data;
filter the corresponding text data based on a maximum value of the NPS and a minimum value of the NPS; and
train a model based on the filtered text data and the corresponding maximum or minimum value of the NPS.

12. The computing apparatus of claim 11, wherein the instructions further configure the apparatus to:
receive test data comprising human-based labeled test data from a plurality of subject matter experts related to a service application of the NPS; and
evaluate the model based on the test data.

13. The computing apparatus of claim 12, wherein evaluating the model further comprises:
determine an accuracy of the model based on a comparison of an outcome based on the model with an outcome based on the human-based test data.

14. The computing apparatus of claim 13, wherein the instructions further configure the apparatus to:
retrain the model in response to determining that the accuracy of the model is lower than an accuracy threshold.

15. The computing apparatus of claim 13, wherein the instructions further configure the apparatus to:
receive a first NPS score and corresponding first text data;
in response to determining that the accuracy of the model is higher than an accuracy threshold,
determine a sentiment of the first text data based on the model and the first NPS score,
the sentiment include a binary indicator, the binary indicator indicating either a positive sentiment for the first text data or a negative sentiment for the first text data.

16. The computing apparatus of claim 11, wherein the text data includes feedback data related to a service application.

17. The computing apparatus of claim 11, wherein the NPS includes a range from the minimum value to the maximum value.

18. The computing apparatus of claim 17, wherein the maximum value corresponds to a positive sentiment, and the minimum value corresponds to a negative sentiment.

19. The computing apparatus of claim 11, wherein the instructions further configure the apparatus to:
process the filtered text data using a text analysis engine.

20. A non-transitory computer-readable storage medium, the computer-readable storage medium including instructions that when executed by a computer, cause the computer to:
access net promoter scores (NPS) and corresponding text data;
filter the corresponding text data based on a maximum value of the NPS and a minimum value of the NPS; and
train a model based on the filtered text data and the corresponding maximum or minimum value of the NPS.
